(19) United States
(12) Patent Application Publication
(10) Pub. No.: US 2009/0161625 A1
(43) Pub. Date: Jun. 25, 2009

(54) SEAMLESS MOBILITY FOR NON-MOBILE INTERNET PROTOCOL CAPABLE WIRELESS DEVICES IN A TIME DIVISION DUPLEX SYSTEM

(75) Inventors: Pramod Karnam, Rolling Meadows, IL (US); Ravi M. Adatrao, West Dundee, IL (US); Seth M. Marks, Crystal Lake, IL (US); Paula Tjandra, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/960,085

(22) Filed: Dec. 19, 2007

(51) Int. Cl. H04Q 7/20

(52) U.S. Cl. 370/331

(57) ABSTRACT

A method, base station, and wireless communication system provide seamless mobility in a time division duplex system. The method includes determining a mobility capability of the wireless communication device (104). In response to determining that the mobility capability of the wireless communication device (104) may involve a network address change for a new sub-network (204), an identification of at least one neighboring base station (208) is provided to the wireless communication device (104) that the wireless communication can select to be handed into.

### FIELD OF THE INVENTION

The present invention generally relates to the field of wireless communications, and more particularly relates to handover procedures for subnets within a wireless communication network.

### BACKGROUND OF THE INVENTION

In Time Division Duplex (“TDD”) systems such as an 802.16 WiMax system, a network can comprise multiple sub-networks (“subnets”). One problem with current 802.16 WiMax systems is that wireless devices are unable to distinguish between a neighbor base station that is in a different subnet from a neighbor base station within its current subnet. Mobile Internet Protocol (“MIP”) capable devices can transition into a new subnet during an active session without the session being dropped. The MIP capable device is assigned a new IP address when it enters the new subnet. However, not all wireless devices are MIP capable. If a non-MIP capable device selects a neighbor base station for handover procedures that is not in its current subnet, the active session of the device is dropped. The device is required to perform a full network entry (re-register) with the new base station and re-establish its session.

Therefore a need exists to overcome the problems with the prior art as discussed above.

### SUMMARY OF THE INVENTION

Briefly, in accordance with the present invention, disclosed are a method, base station, and wireless communication system for providing seamless mobility. The method includes determining a mobility capability of the wireless communication device. In response to determining that the mobility capability of the wireless communication device may involve a network address change for a new sub-network, an identification of at least one neighboring base station is provided to the wireless communication device that the wireless communication can select to be handed into.

In another embodiment, a base station for providing seamless mobility in a time division duplex system is disclosed. The base station includes a transceiver and a processing unit that comprises a processor communicatively coupled to a memory. The processing unit is adapted to determining a mobility capability of the wireless communication. In response to determining that the mobility capability of the wireless communication device may involve a network address change for a new sub-network, an identification of at least one neighboring base station is provided to the wireless communication device that the wireless communication can select to be handed into.

In yet another embodiment, a wireless communication system is disclosed. The wireless communication system includes a plurality of base stations, each base station in the plurality of base stations being communicatively coupled to at least one wireless communication device. At least one base station includes a mobility manager that is adapted to determining a mobility capability of the wireless communication. In response to determining that the mobility capability of the wireless communication device may involve a network address change for a new sub-network, an identification of at least one neighboring base station is provided to the wireless communication device that the wireless communication can select to be handed into.

An advantage of the foregoing embodiments of the present invention is that a base station can influence a wireless device to scan certain preferred base stations. This prevents a non-MIP capable device from moving into a base station that is not in the same subnet. Accordingly, a non-MIP device does not loose its active session because the non-MIP device only moves into base stations within its current subnet.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a wireless communication system, according to an embodiment of the present invention;

FIG. 2 is diagram illustrating various subnets within a time division duplex system;

FIG. 3 is timing diagram illustrating an example of preventing a non-Mobile Internet Protocol capable wireless device from being handed over into a different sub-network according to an embodiment of the present invention;

FIG. 4 is a block diagram illustrating a detailed view of a base station according to an embodiment of the present invention;

FIG. 5 is a block diagram illustrating a detailed view wireless communication device, according to an embodiment of the present invention; and

FIG. 6 is an operational flow diagram illustrating a process of preventing a non-Mobile Internet Protocol capable wireless device from being handed over into a different sub-network according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The term wireless communication device is intended to broadly cover many different types of devices that can wirelessly receive signals, and optionally can wirelessly transmit signals, and may also operate in a wireless communication system. For example, and not for any limitation, a wireless communication device can include any one or a combination of the following: a cellular telephone, a mobile phone, a smartphone, a two-way radio, a two-way pager, a wireless messaging device, a laptop/computer, automotive gateway, residential gateway, and the like.

Wireless Communication System

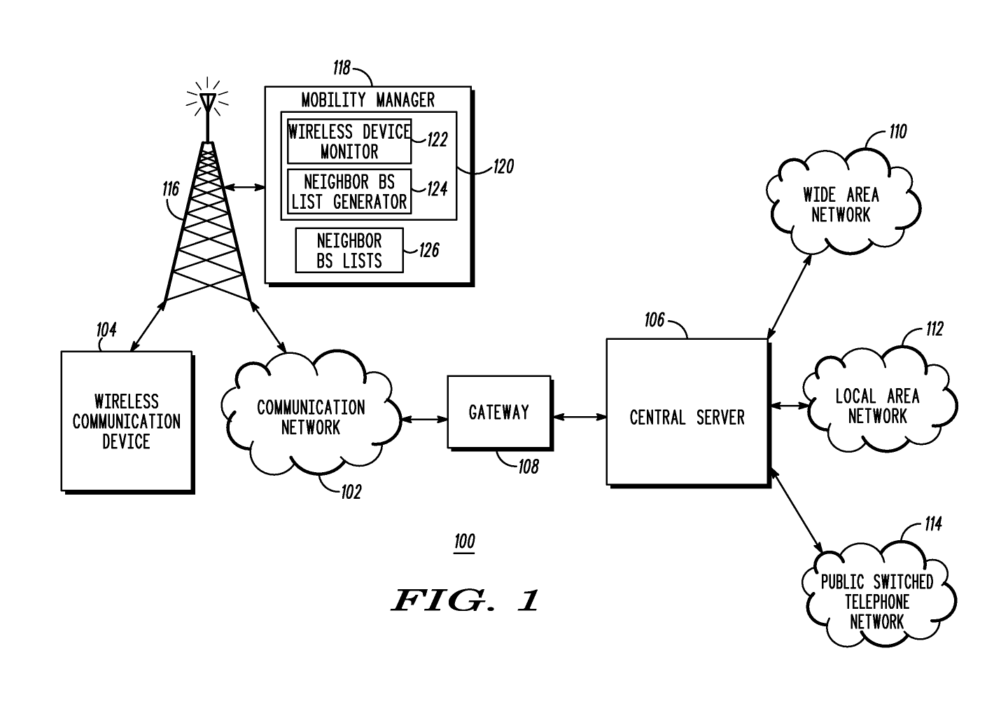

According to one embodiment of the present invention, as shown in FIG. 1, a wireless communication system 100 includes a communication network 102 that connects one or more wireless communication devices 104 to one another, various networks, and other communication devices. The communication network 102, according to the present example, comprises a mobile phone network, a mobile text messaging device network, a pager network, or a similar type of network.

Further, the communications standard of the communication network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA), IEEE 802.16 family of standards, Orthogonal Frequency Division Multiplexing (OFDM), Orthogonal Frequency Division Multiple Access (OFDMA), Wireless LAN (“WLAN”), WiMAX or the like. Additionally, the communication network 102 also comprises text messaging standards, for example, Short Message Service (SMS), Enhanced Messaging Service (EMS), Multimedia Messaging Service (MMS), or the like. The communication network 102 also allows for push-to-talk over cellular communications between capable wireless communication devices.

The communication network 102 supports any number of wireless communication devices 104. The support of the communication network 102 includes support for mobile telephones, smart phones, text messaging devices, handheld computers, pagers, beepers, wireless communication cards, personal computers with wireless communication adapters, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

In one embodiment, the communication network 102 is capable of broadband wireless communications utilizing time division duplexing (“TDD”) as set forth, for example, by the IEEE 802.16e standard. The IEEE 802.16e standard is further described in IEEE Std. 802.16e 2005. The duplexing scheme TDD allows for the transmissions of signals in a downstream and upstream direction using a single frequency. It should be noted that the present invention is not limited to an 802.16e system for implementing TDD. Other communication systems that the present invention may be applied to include systems utilizing standards such as UMTS LTE (Long Term Evolution), IEEE 802.20, and the like.

Furthermore, the wireless communication system 100 is not limited to a system using only a TDD scheme. For example, TDD may be only used for a portion of the available communication channels in the system 100, while one or more schemes are used for the remaining communication channels. The wireless communication devices 104 in one embodiment, are capable of wirelessly communicating data using the 802.16e standard or any other communication scheme that supports TDD. In another embodiment, the wireless communication devices 104, 106 are capable of wireless communications using other access schemes in addition to TDD.

The wireless communication system 100 also includes one or more information processing systems 106 such as a central server communicatively coupled to the communication network 102 via a gateway 108. The information processing system 106 maintains and process information for all wireless devices 104 communicating on the communication network 102. Additionally, the information processing system 106 communicatively couples the wireless devices 104 to a wide area network 110, a local area network 112, and a public switched telephone network 114 through the communication network 102. Each of these networks 110, 112, 114 has the capability of sending data, for example, a multimedia text message, to the wireless devices 104.

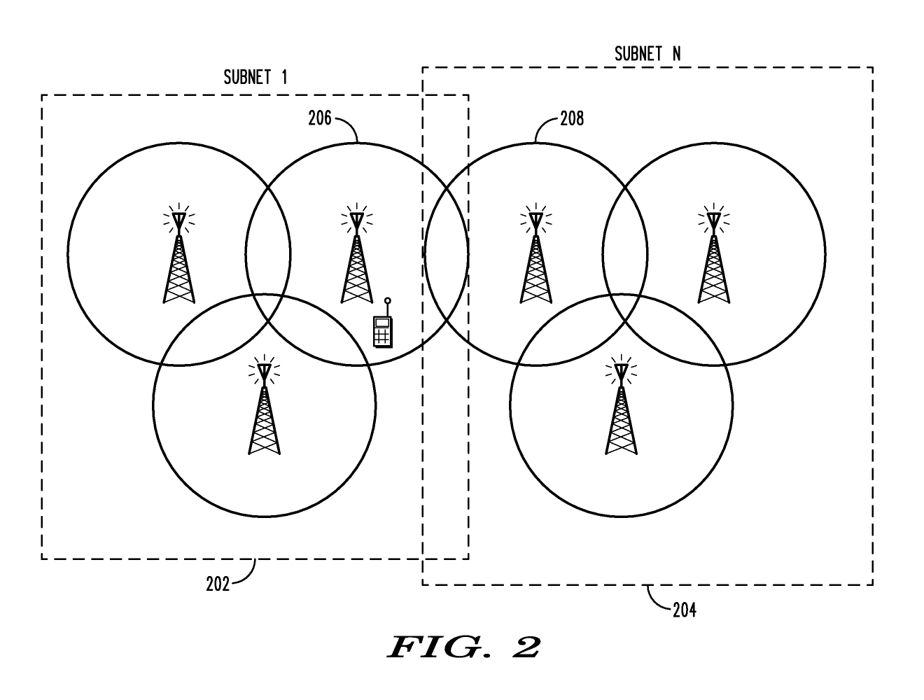

The wireless communication system 100 also includes a group of base stations 116. FIG. 1 only shows one base station 116 for simplicity. In one embodiment, each base station 116 comprises part of a sub-network of the communication network 102. For example, FIG. 2 shows a first subnet 202 and a second subnet 204. Each subnet comprises one or more base stations. As can be seen, each base station within a subnet has neighboring base stations. Some base stations such as base station 206 have neighboring base stations in a different subnet such as base station 208.

As discussed above, WiMax systems provide mobility across subnets via MIP. However, classes of users such as small commercial deployments systems do not require MIP and want to limit mobility to base stations within a specific subnet. Returning back to FIG. 1, a site controller 118 for a serving base station 116 includes a mobility manager 120. The mobility manager 120, in one embodiment, prevents a non-MIP wireless device from moving into a base station that is not in its current subnet. Therefore, if a non-MIP device has an active session, the device is prevented from moving into a new subnet where the active session is dropped.

The mobility manager 120, in one embodiment, includes a wireless device monitor 122 and a neighbor base station list generator 124. The wireless device monitor 122, in one embodiment, determines when a wireless device 104 is requesting a handover operation to a new base station. Alternatively, the wireless device monitor 122 can determine that a wireless device 104 is to be handed over to a new base station without receiving a request from the wireless device 104. In this embodiment, the base station 116 initiates handover procedures. Current WiMax systems support a Neighbor advertisement procedure and a Scan response procedure that allow the network to advertise neighbor base stations. However, the Current WiMax systems do not a subscriber device's mobility limitations. In other words, current WiMax systems do not determine whether a wireless device is MIP capable/non-MIP capable when advertising neighbor base stations.

Embodiments of the present invention, on the other hand, do take into account the mobility capabilities of a wireless device 104. For example, the wireless device monitor 122, in one embodiment, determines the mobility capabilities of a device 104 via its Authentication, Authorization, and Accounting (“AAA”) profile. If the mobility manager 120 determines that a device 104 is a non-MIP device then the neighbor base station list 126 sent to the non-MIP device only includes base stations within the current subnet of the non-MIP device. In one embodiment, the neighbor base station list 126 is generated by a neighbor base station list generator 126. The neighbor base station list 126 can be sent to the non-MIP device via a scan response. The scan response sent to the non-MIP device can be in response to a SCAN-REQ or a Mobile Station Handover Request received from the non-MIP device. The scan response can also be sent to the non-MIP device when it successfully registers with the serving base station 116. In another embodiment, a neighborhood list 126 including neighboring base stations with a current sub-network of a wireless device 104 is transmitted to both MIP and non-MIP wireless devices 104.

Therefore, one embodiment of the present invention allows a base station 116 to influence a wireless device 104 to scan certain preferred base stations. This prevents a non-MIP device from moving into a base station that is not in the same subnet. Accordingly, a non-MIP device does not loose its active session because the non-MIP device only moves into base stations within its current subnet.

Timing Diagram Illustrating One Example of Preventing A Wireless Device From Changing Sub-Networks

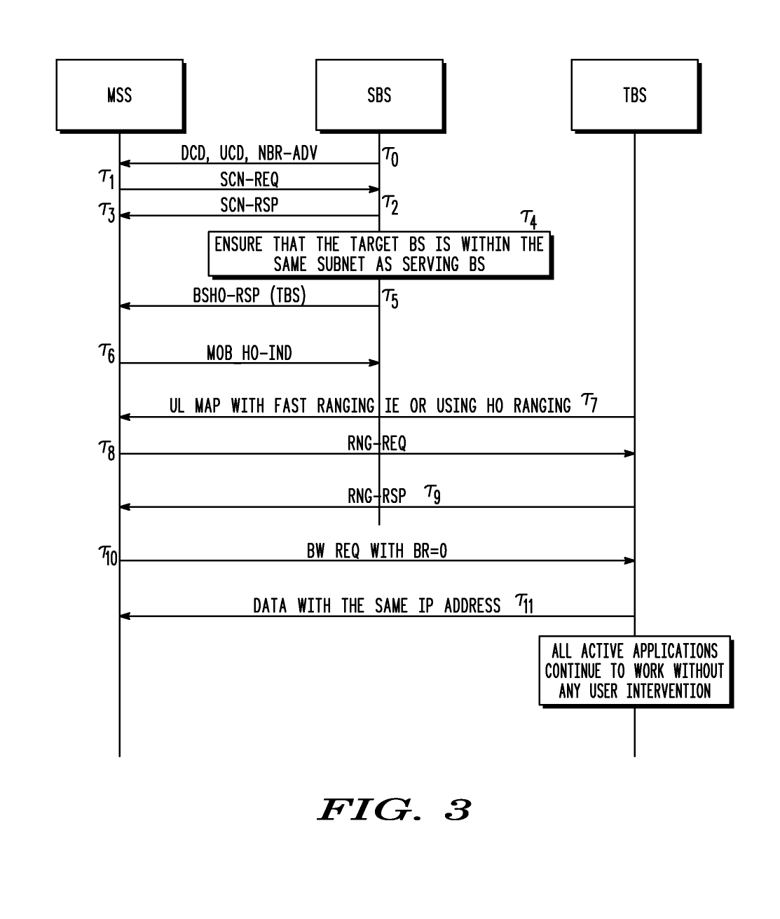

FIG. 3 is a timing diagram showing one example of providing a non-MIP device such as the wireless device 104 a neighbor base station list 126 that only includes base stations within its current subnet. At time T₀, the serving base station (“SBS”) 116 transmits a downlink channel descriptor, uplink channel descriptor, and neighbor-advertisement message to the wireless device 104. The wireless device 104, at time T₁, sends a Scan Request message to the serving base station 116. The serving base station 116, at T₂, responds by sending a Scan Response message to the wireless device 104. The wireless device 104, at time T₃, sends a mobile subscriber handover request to the serving base station 116. For example, the wireless device 104 notifies its serving base station 116 that it wants to hand over into a particular base station.

The serving base station 116, at time T₄, determines whether the target base station is within the current sub-network of the wireless device 104. The serving base station 116, at time T₅, transmits a list 126 of base stations to the wireless device 104 that are within the current sub-network. This list 126 can be transmitted within a base station handover response message. In one embodiment, the serving base station 116 prioritizes base stations within the list 126 sent to the wireless device 104. Also, the list can include a single or multiple base stations. The wireless device 104 uses this list 126 to then select a base station for handover operations. Therefore, one advantage of this embodiment of the present invention is that a serving base station can 116 prevent a wireless device 104 that is non-MIP capable from handing over into a different sub-network when base stations within its current sub-network are available.

The wireless device 104, at time T₆, sends a Mobile Handover Indication to its serving base station 116. This notifies the serving base station 116 to no longer transmit out to the wireless device 104. At times time T₇ to T₁₀, the wireless device 104 and target base station perform various procedures for handing over and registering the wireless device 104 into the target base station. The wireless device 104, at time T₁₁, now communicates with the target base station using the same IP address as it did with the previous base station 116. The IP address of the wireless device 104 did not change because the wireless device 104 did not change sub-networks.

Base Station

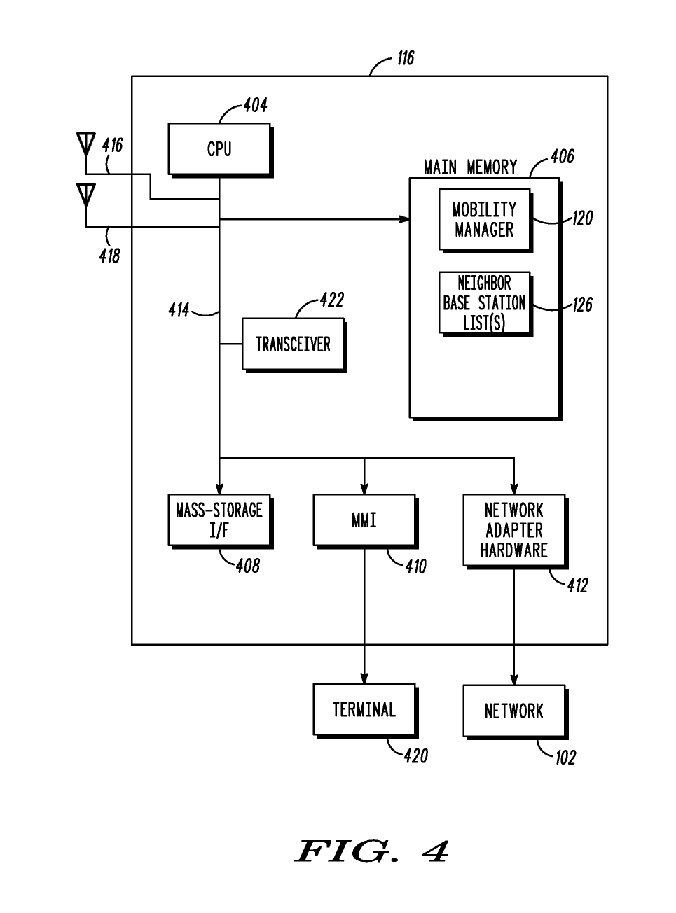

FIG. 4 is a block diagram illustrating a more detailed view of the base station 116 according to one embodiment of the present invention. The following discussion is also applicable to an information processing system such as a site controller (not shown) that controls the base station 116. A site controller (not shown) can reside within its respective base station 116 or can reside outside of respective base station 116. The base station 116 includes a processor 404 that is connected to a main memory 406 (e.g., volatile memory), one or more transceivers 422, non-volatile memory 408, a man-machine interface (“MMI”) 410, and network adapter hardware 412. One or more antennas 416, 418 are also communicatively coupled to the base station 116. A system bus 414 interconnects these system components. The main memory 406 includes the mobility manager 120 discussed above. The components of the mobility manager 120 such as the wireless device monitor 122, and neighbor base station list generator 124 are not shown in FIG. 4 for simplicity. The main memory 408 also includes neighbor base station lists 126. These components have been discussed in greater detail above.

The man-machine interface 410 allows for an administrator, repair crew, or the like to couple a terminal 420 to the base station 116. The network adapter hardware 412 is used to provide an interface to the network 102. For example, the network adapter 416, in one embodiment, provides a connection such as an Ethernet connection (this is only one non-limiting example) between the base station 116 and the communication network 102. One embodiment of the present invention can be adapted to work with any data communications connections including present day analog and/or digital techniques or via a future networking mechanism.

Wireless Communication Device

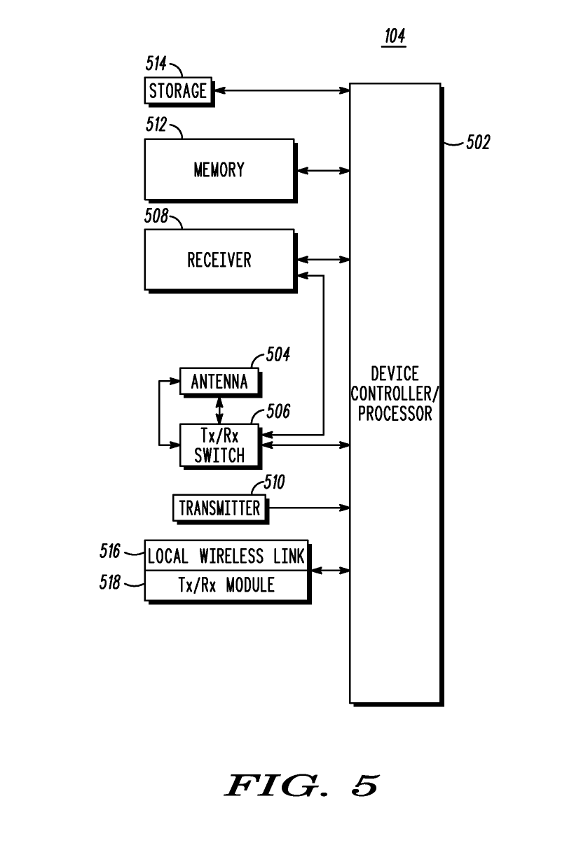

FIG. 5 is a block diagram illustrating a more detailed view of the wireless communication device 104. It is assumed that the reader is familiar with wireless communication devices. To simplify the present discussion, only that portion of a wireless communication device that is relevant to the present example will be discussed. It should be noted that other wireless communication devices such as wireless communication air interface cards (not shown) are also compatible with the present invention. FIG. 5 illustrates only one example of a wireless communication device type.

In one embodiment, the wireless communication device 104 is capable of transmitting and receiving wireless information on the same frequency such as in an 802.16e system using TDD. The wireless communication device 104 operates under the control of a device controller/processor 502, that controls the sending and receiving of wireless communication signals. In receive mode, the device controller 502 electrically couples an antenna 504 through a transmit/receive switch 506 to a receiver 508. The receiver 508 decodes the received signals and provides those decoded signals to the device controller 502.

In transmit mode, the device controller 502 electrically couples the antenna 504, through the transmit/receive switch 506, to a transmitter 510. The device controller 502 operates the transmitter and receiver according to instructions stored in the memory 512. These instructions can include, for example, a neighbor cell measurement-scheduling algorithm.

The wireless communication device 104 also includes non-volatile storage memory 514 for storing, for example, an application waiting to be executed (not shown) on the wireless communication device 104. The wireless communication device 104, in this example, also includes an optional local wireless link 516 that allows the wireless communication device 104 to directly communicate with another wireless device without using a wireless network The optional local wireless link 516, for example, is provided by Bluetooth, Infrared Data Access (IrDA) technologies, or the like. The optional local wireless link 516 also includes a local wireless link transmit/receive module 518 that allows the wireless device 104 to directly communicate with another wireless communication device.

Process of Preventing a Wireless Device from Changing Sub-Networks

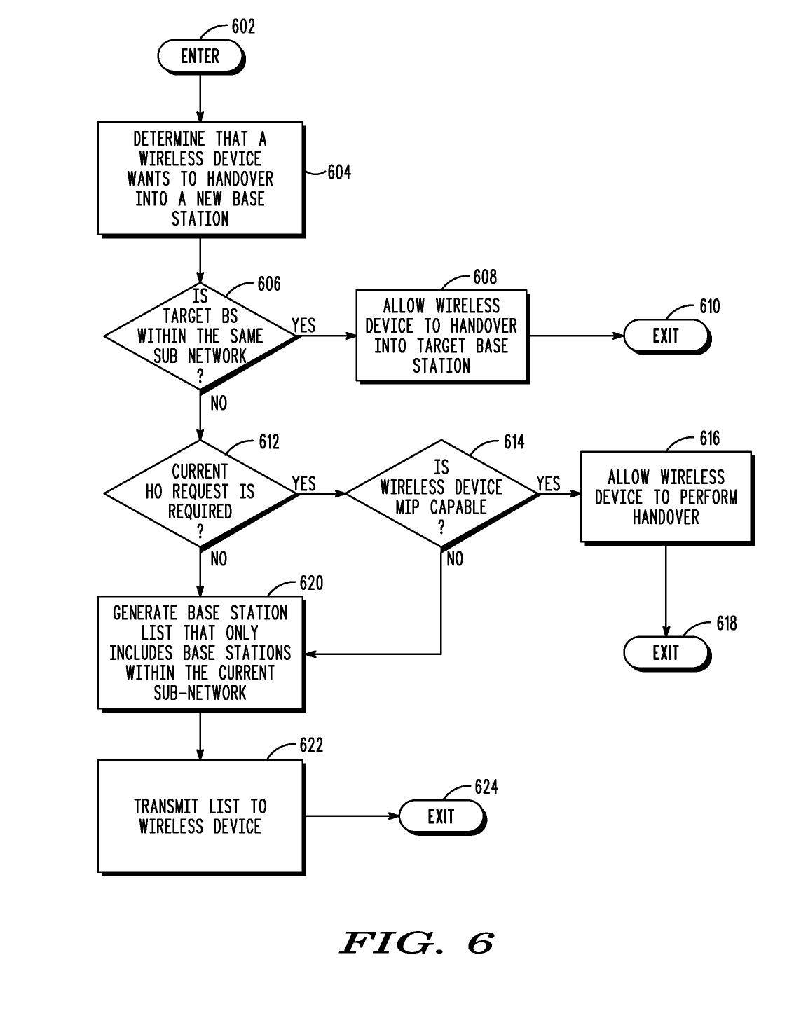

FIG. 6 is an operational flow diagram illustrating a process of preventing a non-MIP capable wireless device from handing over into a new sub-network when base stations within its current sub-network are available. The operational flow diagram of FIG. 6 begins at step 602 and flows directly to step 604. The mobility manager 120, at step 604, determines that a wireless device 104 wants to handover into a new base station 116. The mobility manager 120, at step 606, determines if the target base station is within the same sub-network as the wireless device 104.

If the result of this determination is positive, the mobility manager 120, at step 608, allows the wireless device 104 to handover into the target base station area. The control flow then exits at step 610. If the result of this determination is negative, the mobility manager 120, at step 612, determines if a handover request is required. If the result of this determination is positive, the mobility manager 120, at step 614, determines if the wireless device 104 is MIP capable. If the result of this determination is positive, the mobility manager 120, at step 646, allows the wireless device 104 to handover (i.e., change sub-networks). The control flow then exits at step 618. If the result of the determination at step 614 is negative, the control flows to step 620. If the result of this determination at step 612 is negative, the mobility manager 120, at step 620, generates a base station list that includes base stations within the current sub-network of the wireless device 104. Therefore, the wireless device 104 selects a base station 116 within its current sub-network. The mobility manager 120, at step 622, transmits this list to the wireless device 104. The control flow then exits at step 624.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for providing seamless mobility comprising:
determining a mobility capability of a wireless communication device; and
providing, in response to determining that a mobility capability of the wireless communication device may involve a network address change for a new sub-network, an identification of at least one neighboring base station to the wireless communication device that the wireless communication device can select to be handed into.

2. The method of claim 1, further comprising:
determining that the wireless communication device is requesting to handover into another base station.

3. The method of claim 2, further comprising:
determining that the another base station is located in a different sub-network than a sub-network that the wireless communication device is currently registered in.

4. The method of claim 1, further comprising:
initiating a handover procedure at the wireless communication device.

5. The method of claim 1, wherein the providing the list of neighboring base stations further comprises:
including only neighboring base stations located within a sub-network in which the wireless communication device is currently registered in.

6. The method of claim 5, wherein the list of neighboring base stations, including
only neighboring base stations located within a sub-network in which the wireless communication device is currently registered in, is provided to at least one of
a wireless communication device comprising a mobility capability requiring a network address change for a new sub-network, and
a wireless communication device comprising a mobility capability that allows for a network address currently assigned to the wireless communication device to be used for the new sub-network.

7. The method of claim 1, wherein the determining the mobility capability further comprises:
analyzing an Authentication, Authorization, and Accounting profile associated with the wireless communication device.

8. The method of claim 1, wherein the providing comprises preventing the wireless communication device from selecting a base station to be handed into that is in a different sub-network than a sub-network where the wireless communication device is currently registered in.

9. The method of claim 1, further comprising:
determining that a wireless communication device is requesting to handover into another base station; and
receiving a mobile station handover request from the wireless communication device.

10. A base station for providing seamless mobility comprising:
a transceiver;
a processing unit, comprising a processor communicatively coupled to a memory, adapted to:
determine that a wireless communication device is requesting to handover into another base station;
determine a mobility capability of the wireless communication device; and
provide via the transceiver, in response to determining that the mobility capability of the wireless communication device may involve a network address change for a new sub-network, an identification of at least one neighboring base station to the wireless communication device that the wireless communication can select to be handed into.

11. The base station of claim 10, wherein the processing unit is further adapted to:
determine that the wireless communication device is requesting to handover into another base station that is located in a different sub-network than a sub-network that the wireless communication device is currently registered in.

12. The base station of claim 10, wherein the processing unit is further adapted to:
initiate a handover procedure at the wireless communication device.

13. The base station of claim 10, wherein the processing unit is further adapted to:
determine that the another base station is located in a different sub-network than a sub-network that the wireless communication device is currently registered in; and
wherein providing the identification of at least one neighboring base station to the wireless communication device prevents the wireless communication device from selecting a base station to be handed into that is in a different sub-network than a sub-network where the wireless communication device is currently registered in.

14. The base station of claim 10, wherein the processing unit is further adapted to:
provide, in response to determining that the mobility capability of the wireless communication device may involve a network address change for a new sub-network, a list of neighboring base stations; and
include in the list only neighboring base stations located within a sub-network in which the wireless communication device is currently registered in.

15. The base station of claim 10, wherein the providing the identification of at least one neighboring base station to the wireless communication device prevents the wireless communication device from selecting a base station to be handed into that is in a different sub-network than a sub-network where the wireless communication device is currently registered in.

16. A wireless communication system comprising:
a plurality of base stations, each base station in the plurality of base stations being communicatively coupled to at least one wireless communication device, wherein at least one base station includes a mobility manager adapted to:
determine that a wireless communication device is requesting to handover into another base station;
determine a mobility capability of the wireless communication device; and
provide, in response to determining that the mobility capability of the wireless communication device may involve a network address change for a new sub-network, an identification of at least one neighboring base station to the wireless communication device that the wireless communication can select to be handed into.

17. The wireless communication system of claim 16, wherein the mobility manager is further adapted to at least one of:
determine that the wireless communication device is requesting to handover into the another base station; and
initiate a handover procedure at the wireless communication device.

18. The wireless communication system of claim 16, wherein the mobility manager is further adapted to:
determining that another base station is located in a different sub-network than a sub-network that the wireless communication device is currently registered in.

19. The wireless communication system of claim 16, wherein the mobility manager is further adapted to:
provide, in response to determining that the mobility capability of the wireless communication device may involve a network address change for a new sub-network, a list of neighboring base stations; and
include in the list only neighboring base stations located within a sub-network in which the wireless communication device is currently registered in.

20. The wireless communication system of claim 16, wherein the mobility manager provides the identification of the at least one neighboring base station to the wireless communication device to prevent the wireless communication device from selecting a base station to be handed into that is in a different sub-network than a sub-network where the wireless communication device is currently registered in.
